(19) United States
(12) Patent Application Publication
(10) Pub. No.: US 2026/0220586 A1
(43) Pub. Date: Jul. 30, 2026

(54) System and Method for Optimizing Packing and Shipping Configurations Using Parallel Processing

(71) Applicant: Tomas David Ye, West Orange, NJ (US)

(72) Inventor: Tomas David Ye, West Orange, NJ (US)

(21) Appl. No.: 19/037,401

(22) Filed: Jan. 27, 2025

(51) Int. Cl. G06Q 10/083

(52) U.S. Cl. CPC G06Q 10/083

(57) ABSTRACT

A system for optimizing packing and shipping configurations includes multiple parallel processing agents, each generating and evaluating candidate packing configurations based on input data, including item dimensions, weights, allowable box sizes, and shipping parameters. The processing agents incorporate a solution generator, an optimization module for evaluating configurations against constraints, and a validation module utilizing three-dimensional packing algorithms. A solution exchange module facilitates the transfer of high-performing configurations between agents, enhancing diversity in candidate solutions. An iterative refinement module dynamically adjusts parameters, such as fill rates, to resolve failed configurations. A control module selects an optimized packing configuration from the validated solutions, which is output via a communication interface.

### FIELD OF INVENTION.

The present invention relates to systems and methods for optimizing packing and shipping configurations, particularly utilizing parallel processing agents, iterative refinement, and three-dimensional packing algorithms for cost-effective and efficient logistics operations.

### BACKGROUND

The efficient management of supply chain logistics has become increasingly critical in the modern era, driven by the rapid growth of e-commerce and the complexities of global distribution networks. Companies must navigate significant challenges in managing costs associated with shipping and packing while meeting customer expectations for fast and accurate deliveries. The diversity of items, variability in box sizes, weight constraints, and carrier-specific pricing models add layers of complexity to these operations. Despite advancements in automation and data-driven decision-making, current systems often fail to address these complexities holistically, leading to inefficiencies and inflated operational costs.

Traditional packing and shipping processes typically rely on heuristic-based methods or manual decision-making. These approaches, while sufficient for small-scale operations, quickly become inadequate when scaled to handle large, heterogeneous orders. Manual decisions regarding the number of shipments, box type selection, item placement, and carrier pricing structures often result in suboptimal configurations. This leads to unnecessary expenditure, such as oversized boxes, excessive dimensional weight charges, and poorly utilized shipping capacities. The lack of a comprehensive optimization strategy to integrate these variables leaves significant room for improvement in supply chain efficiency.

Existing automated systems attempt to address these inefficiencies through static algorithms or rule-based optimizations. While these systems may handle specific constraints like weight limits or dimensional restrictions, they are generally incapable of adapting dynamically to varying input parameters or exploring alternative configurations effectively. Many rely on single-point optimization models that prioritize a single variable, such as cost or weight, without adequately balancing the interplay of multiple factors. As a result, these systems often miss opportunities to achieve holistic cost savings across the entire supply chain.

Additionally, the lack of robust algorithms capable of efficiently managing complex configurations contributes to the persistence of inefficiencies in the industry. For example, while some systems incorporate 2D or basic 3D-packing techniques, they often fail to account for real-world constraints, such as item fragility, irregular shapes, and compatibility requirements. This can lead to configurations that are theoretically optimal but impractical for real-world application, necessitating manual intervention and further undermining efficiency.

Another significant drawback of existing systems is their inability to effectively integrate with human operators in warehouse environments. Current solutions often lack intuitive user interfaces or fail to provide actionable guidance to packing staff, resulting in errors, delays, and inconsistencies in packing quality. Without a user-centric design, these systems struggle to bridge the gap between computational optimization and real-world implementation. These limitations collectively underscore the need for innovative solutions that can dynamically balance constraints, optimize cost-effectiveness, and enhance usability in real-world logistics environments.

It is within this context that the present invention is provided.

### SUMMARY

The invention provides a system for optimizing packing and shipping configurations using a combination of parallel processing agents and iterative refinement techniques. The system comprises multiple processing agents that operate concurrently to generate, evaluate, and refine candidate packing configurations based on input data, including item dimensions, weights, allowable box sizes, and shipping parameters. Each processing agent uses a solution generator to create potential configurations, an optimization module to evaluate their feasibility under defined constraints, and a validation module to confirm the spatial feasibility of the packing configurations using three-dimensional packing algorithms. The system dynamically adjusts parameters such as fill rates when configurations fail constraints, ensuring the generation of feasible and efficient solutions. Optimized configurations are selected by a control module and output to downstream systems for implementation.

The system incorporates a mechanism for communication between the parallel processing agents, enabling the exchange of high-performing solutions to maintain diversity and avoid local optimization plateaus. This approach enhances the robustness of the solution generation process and increases the likelihood of achieving efficient packing configurations across various operational scenarios.

In some embodiments, the solution generator employs a biased random-key genetic algorithm to produce candidate configurations. This ensures diverse and prioritized item-to-box assignments, improving the breadth of potential solutions and enhancing the optimization process.

In further embodiments, the optimization module refines candidate configurations using mixed integer linear programming to ensure compliance with packing constraints. This integration improves the feasibility of the generated configurations by leveraging mathematical optimization techniques.

In yet further embodiments, the communication between agents is facilitated by a solution exchange module that transmits elite solutions between agents at defined intervals. This promotes diversity in the populations of candidate solutions across agents and enhances overall system efficiency.

In some embodiments, the iterative refinement module adjusts fill rate parameters incrementally when candidate configurations fail to meet constraints. This dynamic adjustment ensures that packing configurations remain adaptable to varying input conditions and constraints.

In further embodiments, the validation module employs a three-dimensional bin-packing algorithm to confirm the spatial feasibility of packing configurations. This enables the system to account for complex spatial arrangements and constraints, such as item orientation and fragility.

In yet further embodiments, the three-dimensional bin-packing algorithm incorporates additional constraints, including item compatibility and orientation rules. These features enhance the practical applicability of the system to real-world packing scenarios.

In some embodiments, the system operates across a distributed computing network, enabling parallel processing agents to execute independently while maintaining synchronization through the solution exchange module. This architecture supports scalability and high-performance optimization.

In further embodiments, the communication interface outputs optimized configurations to a gamified user interface. The interface displays real-time metrics, including weight and volume utilization, and provides actionable guidance to operators, ensuring efficient implementation of the packing solutions.

In yet further embodiments, the system incorporates mutation mechanisms in the genetic algorithm to introduce variability into candidate solutions. This prevents stagnation in local optima and improves the exploration of the solution space.

In some embodiments, the system evaluates candidate configurations using a cost function that considers shipping rates, box costs, and penalties for constraint violations. This approach provides a balanced optimization strategy to minimize overall costs.

In further embodiments, the iterative refinement module adjusts additional parameters, such as box types and shipment counts, when refining configurations. This ensures adaptability to varying operational constraints and requirements.

In yet further embodiments, the system integrates with external carrier systems to retrieve real-time shipping rate data, enabling accurate cost evaluations that reflect current market conditions.

In some embodiments, the system outputs a machine-readable version of the optimized packing configuration for seamless integration with warehouse management systems. This facilitates the automation of downstream packing and shipping processes.

### BRIEF DESCRIPTION OF THE DRAWINGS

Various embodiments of the invention are disclosed in the following detailed description and accompanying drawings.

FIG. 1 illustrates an example system architecture for optimizing packing and shipping configurations using parallel processing agents.

FIG. 2 illustrates an example process flow diagram for the Price-Aware Genetic Packing Algorithm to generate optimized packing and shipping solutions.

FIG. 3A illustrates an example user interface associated with retrieving order data from a warehouse management system in the first step of the process.

FIG. 3B illustrates an example user interface associated with evaluating shipping configurations generated by multiple AI agents in the second step of the process.

FIG. 3C illustrates an example user interface associated with guiding packers through the physical packing process using real-time metrics and gamified elements.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “first,” “second,” and the like are used to distinguish different elements or features, but these elements or features should not be limited by these terms. A first element or feature described can be referred to as a second element or feature and vice versa without departing from the teachings of the present disclosure.

The term “processing agent” refers to any computational entity, software module, or hardware-based system configured to generate, evaluate, or refine candidate packing configurations. This includes, but is not limited to, virtualized instances on cloud-based systems, dedicated processing units within distributed networks, or locally deployed software applications. In one example implementation, a processing agent may be a virtual machine hosted on a cloud platform, executing algorithms to optimize item-to-box assignments based on predefined constraints and cost functions.

The term “candidate packing configuration” refers to any proposed arrangement of items, boxes, and shipments generated by the system for evaluation. This includes, but is not limited to, configurations specifying item placements, box sizes, shipping methods, and shipment counts. In one example implementation, a candidate packing configuration may define a setup where items with high fragility are assigned to smaller boxes with padding, while non-fragile items are consolidated into larger containers to maximize space utilization.

The term “solution generator” refers to a module or component within a processing agent responsible for creating initial or refined packing configurations. This includes, but is not limited to, software routines implementing heuristic methods, genetic algorithms, or rule-based frameworks. In one example implementation, the solution generator may use a biased random-key genetic algorithm to prioritize item assignments, ensuring that items with similar dimensions or constraints are grouped efficiently.

The term “optimization module” refers to a software or hardware component that evaluates candidate packing configurations against a cost function and constraints. This includes, but is not limited to, modules using mixed integer linear programming, linear programming, or constraint-based optimization techniques. In one example implementation, the optimization module may calculate shipping costs based on real-time carrier rate data, while ensuring that all box and weight constraints are satisfied.

The term “validation module” refers to a component responsible for verifying the feasibility of packing configurations by simulating or analyzing spatial arrangements. This includes, but is not limited to, modules using two-dimensional or three-dimensional packing algorithms, with or without additional constraints such as item orientation or fragility. In one example implementation, the validation module may utilize a three-dimensional bin-packing algorithm to arrange irregularly shaped items within a box, taking into account specified orientation rules.

The term “iterative refinement module” refers to a component configured to adjust parameters of packing configurations dynamically when constraints are violated. This includes, but is not limited to, modules capable of modifying fill rates, box dimensions, or shipment counts. In one example implementation, the iterative refinement module may decrease the allowable fill rate for boxes in 5% increments until a feasible configuration is achieved.

The term “communication interface” refers to any system or component that facilitates the transfer of data between the system and external systems or users. This includes, but is not limited to, APIs, graphical user interfaces, and machine-readable outputs. In one example implementation, the communication interface may generate a JSON file containing detailed packing configurations for integration with a warehouse management system, or a GUI that displays real-time packing instructions to operators.

The term “three-dimensional packing algorithm” refers to any computational method for arranging items within a container to optimize spatial usage while satisfying constraints. This includes, but is not limited to, algorithms based on heuristic methods, dynamic programming, or greedy approaches. In one example implementation, the algorithm may arrange items with specific orientation constraints, such as requiring upright placement for liquids, while maximizing the box's internal volume utilization.

### Description of Drawings

The present invention provides a system and method for optimizing packing and shipping configurations in supply chain logistics, addressing the limitations of existing systems as outlined in the background. Traditional approaches to packing and shipping optimization are often limited by their reliance on static algorithms or manual decision-making, leading to suboptimal configurations that increase costs and operational inefficiencies. These approaches typically fail to adapt dynamically to changing input parameters, such as item dimensions, weights, or carrier-specific pricing structures, and do not sufficiently account for the complex interplay between multiple constraints, such as volume utilization, weight limits, and item compatibility.

The invention introduces a system that employs multiple processing agents operating in parallel to generate, evaluate, and refine candidate packing configurations. These processing agents leverage advanced optimization techniques, including biased random-key genetic algorithms, mixed integer linear programming, and three-dimensional packing algorithms, to explore a broad range of potential configurations while ensuring compliance with defined constraints. By allowing parallel operation and periodic communication between agents, the system enhances solution diversity, avoids local optima, and converges more effectively on globally optimal solutions. This capability is particularly advantageous for large-scale orders involving diverse item types and complex shipping requirements, where traditional methods struggle to achieve both feasibility and efficiency.

In addition to addressing computational inefficiencies, the invention incorporates mechanisms for iterative refinement, enabling dynamic adjustments to key packing parameters, such as box fill rates, in response to constraint violations. This feature ensures that the system can adapt to challenging configurations without requiring manual intervention, reducing delays and improving operational consistency. Furthermore, the use of a three-dimensional packing algorithm for spatial validation ensures that the solutions produced are not only cost-effective but also practical for real-world implementation, accommodating constraints such as item fragility, orientation, and compatibility.

Another important aspect of the invention is the integration of a communication interface that provides actionable outputs in a format suitable for downstream implementation. This may include machine-readable configurations for automated systems or user-friendly, gamified interfaces for guiding warehouse operators during the packing process. By bridging the gap between computational optimization and real-world application, the invention enhances accuracy, reduces human error, and streamlines packing operations.

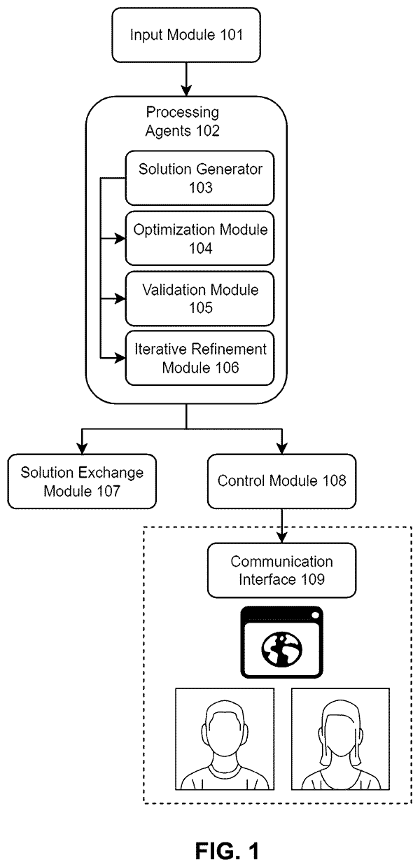

Referring now to the drawings, FIG. 1 illustrates a system architecture for optimizing packing and shipping configurations.

The input module 100 is shown receiving data essential for the operation of the system. This data includes item dimensions, weights, allowable box sizes, and shipping method parameters. Although depicted as a single block, the input module 100 may include separate components for processing data retrieved from external systems, such as warehouse management systems or carrier databases. For instance, in some implementations, the input module 100 may support real-time data retrieval from external shipping carriers to account for dynamic rate updates.

Processing agents 102 are shown as a unified block representing the plurality of parallel agents within the system. Each processing agent 102 operates independently to generate and refine candidate packing configurations. Although illustrated collectively, each agent may be deployed on a distinct computing node within a distributed computing network. Each agent contains a solution generator 104, configured to generate candidate packing configurations using heuristic methods such as biased random-key genetic algorithms. While biased random-key genetic algorithms are one implementation, other heuristic methods such as simulated annealing or ant colony optimization may also be employed.

The optimization module 106 within each processing agent 102 evaluates the candidate packing configurations against a cost function and constraints. These constraints may include, but are not limited to, volume utilization, weight limits, item compatibility, and orientation requirements. The optimization module 106 may leverage mixed integer linear programming for refining solutions, although other mathematical optimization techniques, such as constraint programming or linear programming, may also be suitable.

The validation module 108, also part of each processing agent 102, is configured to verify the feasibility of candidate packing configurations using three-dimensional packing algorithms. The validation module 108 ensures that configurations account for spatial arrangements, including considerations for item orientation, fragility, and compatibility. In some implementations, the three-dimensional packing algorithm may incorporate machine learning models trained on historical packing data to predict feasible arrangements for irregularly shaped items.

The iterative refinement module 110 is shown within each processing agent 102 and is responsible for dynamically adjusting configuration parameters, such as fill rates or allowable box sizes, when a candidate configuration fails constraints. The refinement may be performed in incremental steps, such as reducing the fill rate by 5% per iteration, although other parameter adjustment schemes may be used depending on system requirements.

The solution exchange module 112 is shown interfacing between processing agents 102. This module facilitates the periodic sharing of high-performing candidate configurations among the agents, promoting diversity and improving convergence on globally optimal solutions. Although shown as a distinct module, the solution exchange module 112 may be integrated directly into each processing agent 102 in some implementations, operating as a distributed peer-to-peer communication framework.

The control module 114 is shown receiving outputs from the processing agents 102. This module selects the most optimized packing configuration from among the validated solutions. The selection process may be based on predefined criteria, such as the lowest shipping cost or the highest box utilization efficiency. The control module 114 may also monitor the progress of the processing agents 102 and dynamically adjust their operating parameters to improve performance, such as increasing mutation rates in the solution generator 104 if solution diversity is observed to decline.

The communication interface 116 is depicted outputting the optimized packing configuration. While shown as a single block, the communication interface 116 may include multiple components for generating outputs in different formats. For instance, the interface may produce machine-readable outputs, such as JSON files for integration with warehouse management systems, or visual outputs displayed through a user interface. In some implementations, the user interface may be gamified, providing real-time metrics such as weight and volume utilization for each box and allowing human operators to interactively confirm or adjust packing instructions.

Although FIG. 1 depicts the core components of the system, various modifications and alternatives are possible. For example, the processing agents 102 may include additional modules for handling specialized constraints, such as temperature-sensitive items. Similarly, the validation module 108 may integrate external sensor data, such as real-time dimensions scanned from physical items, to improve the accuracy of spatial feasibility checks.

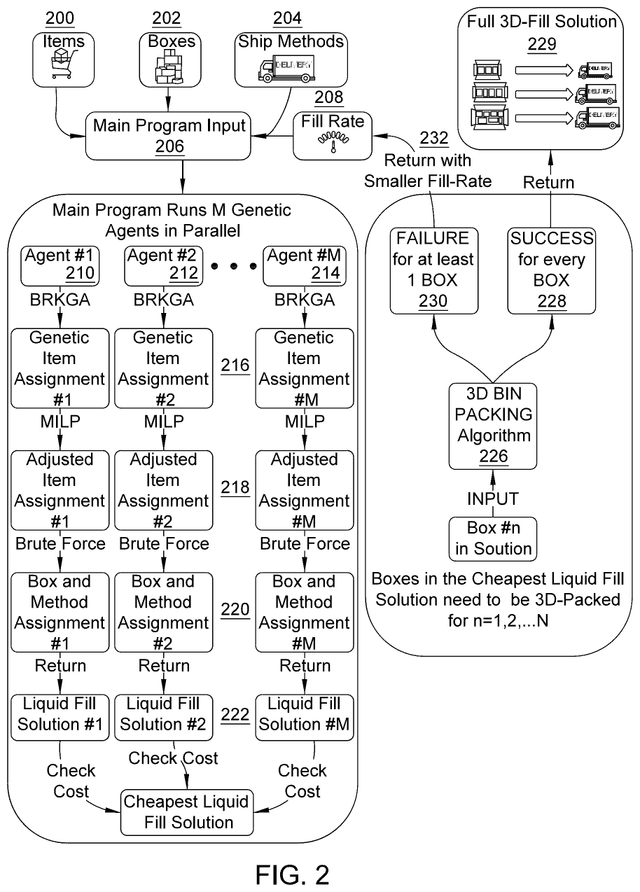

FIG. 2 provides a process flow diagram representing an example implementation of the Price-Aware Genetic Packing Algorithm (PAGPA) for optimizing shipping and packing configurations. This figure outlines the sequential stages and interactions between the components in the system, demonstrating its operation as a specific embodiment of the invention.

The process begins with the main program input 206, which collects three primary types of data. The items 200 include detailed information about the individual items to be shipped, such as their dimensions, weights, fragility, orientation constraints, and compatibility indices. For example, fragile items may be flagged for specific handling, and certain items may have orientation constraints requiring them to remain upright during packing. The boxes 202 represent a list of allowable box types with defined dimensions, volumes, weight limits, and associated costs. The system may support a variety of box types, such as standardized sizes for specific carriers or customized packaging for unique items. The shipping methods 204 include carrier-specific cost functions, such as dimensional weight pricing, flat-rate options, and restrictions based on destination zones. In some implementations, the input module may retrieve real-time rate data from external carrier systems to ensure cost accuracy.

The fill rate control 208 is responsible for setting the initial packing density of the boxes. This parameter may be dynamically modified during the process, enabling iterative refinement of solutions when constraints are violated. For example, the system may initialize the fill rate at 70% of the maximum box capacity and reduce it incrementally in 5% steps during reruns if the initial configuration fails.

The system processes the input data through multiple parallel genetic agents 210, 212, and 214. Each agent operates independently to generate, refine, and evaluate candidate packing configurations. For example, the agents may be deployed across a distributed computing network, enabling scalable and high-performance parallel processing. Each genetic agent 210, 212, and 214 begins with the genetic item assignment 216, where a Biased Random-Key Genetic Algorithm (BRKGA) generates randomized initial solutions. These solutions assign priorities to items based on random values, which are then used to determine item-to-box assignments. For example, items with high priority values may be assigned first to ensure critical constraints, such as fragile item placement, are satisfied early.

The adjusted item assignment 218 is computed by refining the initial genetic solutions using Mixed Integer Linear Programming (MILP). This stage ensures that configurations satisfy constraints such as volume limits, weight limits, and item compatibility. For instance, MILP may adjust an assignment to avoid overloading a box while ensuring that fragile items are packed separately. While MILP is a preferred optimization method, alternative techniques such as constraint programming or linear programming may also be employed in some implementations.

At the box and method assignment 220 stage, the system evaluates each adjusted configuration to determine the most cost-effective box and shipping method. This stage employs a brute force search to calculate the cost function for all feasible combinations of box types and shipping methods, factoring in variables such as carrier rates and dimensional weight charges. For example, the system may select a flat-rate shipping method for heavier items while using dimensional weight pricing for lighter items to minimize costs.

Each genetic agent 210, 212, and 214 outputs a liquid-fill solution 222. This solution specifies the number of shipments, the box types used, and the item assignments within each box. The system evaluates all liquid-fill solutions and selects the cheapest liquid-fill solution 224 across all agents. For example, a solution with the lowest total shipping cost, considering box utilization and carrier rates, may be selected.

The selected liquid-fill solution 224 undergoes validation using the 3D bin-packing algorithm 226. This algorithm arranges items within each box to verify the spatial feasibility of the configuration while satisfying constraints such as item orientation and compatibility. For example, the algorithm may ensure that upright placement requirements for liquid containers are met while maximizing volume utilization within each box. In some implementations, the algorithm may incorporate machine learning models trained on historical packing data to predict feasible arrangements for irregularly shaped items.

If all boxes in the solution pass the 3D-packing constraints, a success outcome 228 is achieved, and the configuration is finalized as a full 3D-fill solution 229. However, if one or more boxes fail the constraints, a failure outcome 230 is triggered. The system responds by rerunning the process with a smaller fill rate 232, as controlled by the fill rate control 208. This iterative refinement ensures that packing configurations are dynamically adjusted to achieve feasibility without manual intervention.

This example implementation demonstrates the system's ability to handle complex optimization tasks through parallel processing, iterative refinement, and robust validation methods. By incorporating elements such as BRKGA in the genetic item assignment 216, MILP in the adjusted item assignment 218, and the 3D bin-packing algorithm 226, the process achieves both cost-effective and feasible packing solutions.

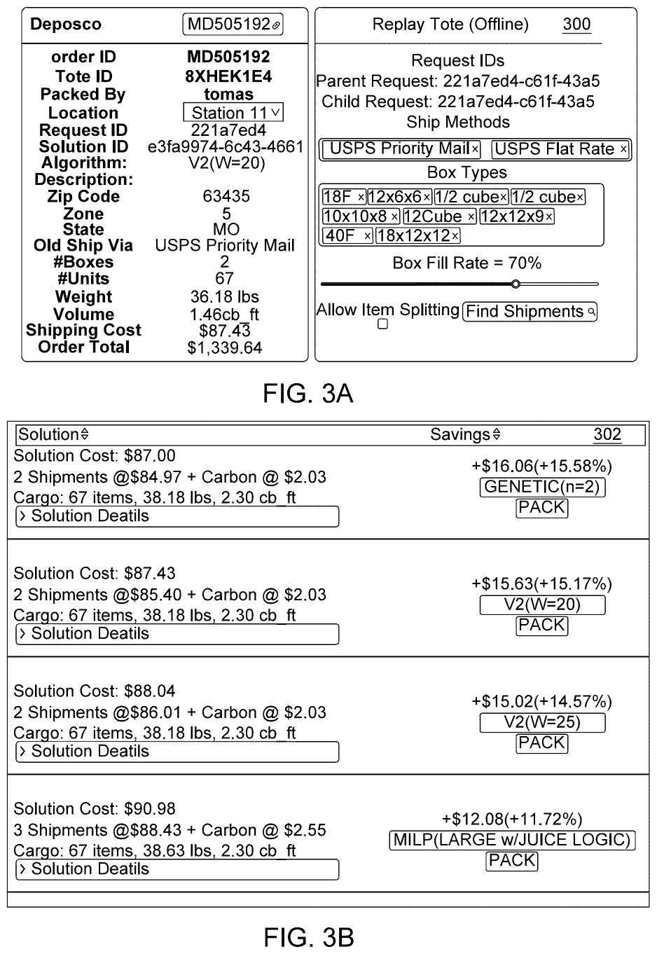

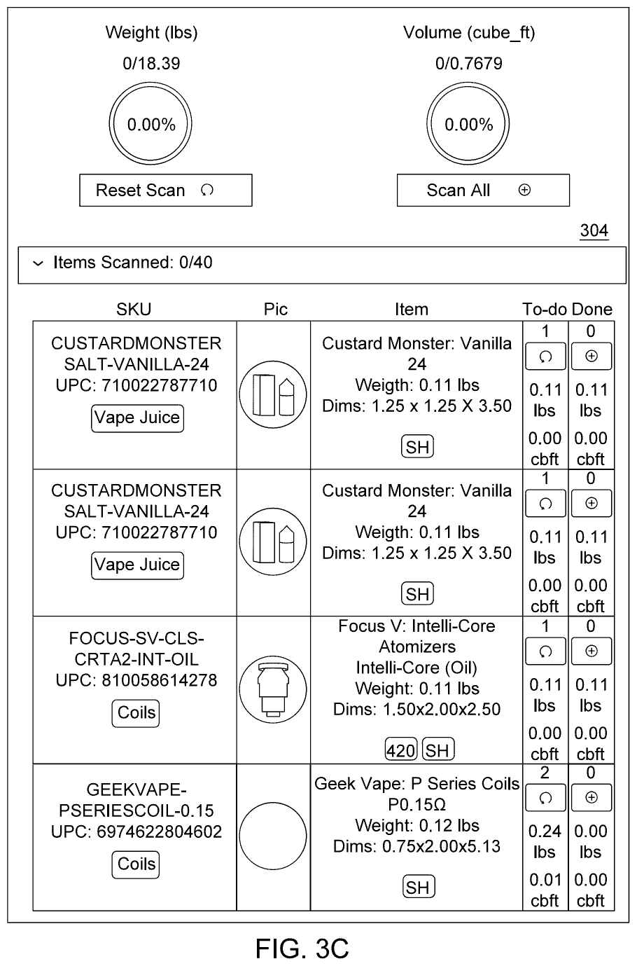

FIG. 3A illustrates an example user interface 300 that facilitates the first step of the system's operation, which involves retrieving and initializing order data from a Warehouse Management System (WMS). This interface is designed to display all relevant input parameters required for the optimization process, ensuring that the system operates based on accurate and complete information.

The user interface 300 prominently shows the details of the specific order being processed. These details include the order ID, which uniquely identifies the order (e.g., MD505192), and the tote ID, which specifies the associated tote for the order (e.g., 8XHEK1E4). Additional metadata displayed includes the name of the individual responsible for packing the order (e.g., Tomas) and the physical location or station where the packing operation is to occur (e.g., Station 11). This information provides traceability and operational context for the packing process.

Technical information related to the optimization process is also presented in the interface 300. The request IDs for the parent and child processes (e.g., 221a7ed4-c61f-43a5) are displayed, allowing for precise tracking of system-generated tasks. The solution ID (e.g., e3fa9974-6c43-4661) is shown, representing the specific packing and shipping configuration generated by the algorithm. The algorithm applied in this instance is indicated as V2(W=20), referring to an optimization approach tailored to specific operational parameters. These technical details ensure that users and downstream systems can understand and verify the processes being employed.

The interface 300 also provides shipping parameters, including the list of allowed box types (e.g., 12×6×6, ½ cube, 10×10×8, 18×12×12) and the initial box fill rate, which is set at 70%. The fill rate slider allows for adjustments, offering flexibility in configuring the packing density based on the specific characteristics of the order. This ensures that the system can account for constraints such as item fragility or box capacity limits.

Order-specific details, such as the destination zip code (e.g., 63435), shipping zone (e.g., 5), and state (e.g., MO for Missouri), are displayed to provide geographical context for the shipment. Additional information includes the calculated shipping cost for the order (e.g., $87.43) and the total order value (e.g., $1,339.64), helping to contextualize the cost of logistics relative to the overall transaction.

The user interface 300 incorporates interactive controls to guide the user. One such control is the “Allow Item Splitting” toggle, which enables the system to allocate items across multiple boxes if necessary. Another prominent feature is the “Find Shipments” button, which initiates the optimization process. Once clicked, this control prompts the system to calculate the most cost-efficient packing and shipping configuration based on the input parameters and constraints.

FIG. 3B illustrates an example user interface 302 associated with the second step of the system's operation, where a tournament of AI agents evaluates shipping configurations to identify the most cost-effective solution. This interface provides a summary of configurations generated by the system's parallel AI agents, along with detailed metrics for comparison and selection.

The interface 302 displays multiple candidate configurations, each representing a distinct packing and shipping strategy generated by the AI agents. These configurations vary in terms of the number of shipments, associated costs, carton prices, total item weight, and total volume. For example, one configuration involves two shipments with a total cost of $ 87.00, a carton price of $ 2.03, a total weight of 38.18 pounds, and a volume of 2.30 cubic feet. Another configuration involves two shipments with a cost of $ 87.43, a carton price of $ 2.03, a total weight of 38.18 pounds, and a volume of 2.30 cubic feet. A third configuration involves two shipments at a cost of $88.04, with a carton price of $2.03, a total weight of 38.18 pounds, and a volume of 2.30 cubic feet. A fourth configuration involves three shipments with a cost of $90.98, a carton price of $ 2.55, a total weight of 38.18 pounds, and a volume of 2.30 cubic feet.

The interface highlights key evaluation metrics for each configuration. These include the total shipping cost, which is derived from carrier rates, box costs, and item assignments; the carton price, representing the average cost per box used; and the total weight and volume of the items, which reflect efficiency in box utilization and compliance with packing constraints. These metrics allow users to assess the trade-offs between cost and packing efficiency for each configuration.

For each configuration, the interface 302 provides an option to view “Solution Details,” allowing users to drill down into specifics such as box assignments, item distribution, and selected shipping methods. This feature ensures transparency and enables users to verify the feasibility and practicality of each proposed solution.

The system automatically selects the configuration with the lowest overall cost, as seen in the highlighted selection for two shipments at $87.00. This process ensures that the chosen configuration meets cost optimization requirements while adhering to the constraints defined during Step 1, such as box dimensions, weight limits, and item compatibility.

The user interface 302 is designed to clearly present the outputs of the AI agents'evaluations, facilitating decision-making and further processing. In some implementations, additional features may be integrated, such as filtering options to prioritize specific criteria (e.g., minimum weight or volume), or visualizations to compare configurations more intuitively.

FIG. 3C illustrates an example user interface 304 associated with the third step of the system's operation, which focuses on guiding the packer through the packing process using an intuitive, interactive, and gamified experience. This user interface is designed to enhance efficiency, accuracy, and user engagement during the physical packing stage.

The user interface 304 prominently displays real-time metrics to assist the packer in monitoring packing progress. Weight progress is shown as the current packed weight versus the target box capacity (e.g., 0 lbs out of 18.39 lbs), alongside a visual indicator reflecting percentage utilization (e.g., 0.00%). Similarly, volume progress is represented as the current packed volume versus the target box capacity (e.g., 0 cubic feet out of 0.7679 cubic feet), with an associated utilization percentage (e.g., 0.00%). These metrics ensure that the packer maintains awareness of the packing status in relation to the defined constraints, reducing the likelihood of overloading or inefficiently packing the box.

The interface 304 includes interactive controls to streamline the packing process. A “Reset Scan” button allows the packer to reset the current scanning progress in case of errors or adjustments. A “Scan All” button enables the bulk scanning of items for faster and more efficient data entry. These controls provide flexibility and adaptability to the packer's workflow, accommodating scenarios where multiple items are processed simultaneously.

A detailed item tracking section is displayed, providing comprehensive information for each item to be packed. This includes the stock-keeping unit (SKU) for internal tracking, the Universal Product Code (UPC) for standardized identification, and a textual description of the item. Visual depictions of the items further assist the packer in identifying them accurately. A “To-Do/Done” column tracks the packing status, showing how many units of each item remain to be packed versus those already packed. For example, the Custard Monster: Vanilla (SKU: CUSTARDMONSTERSALT-VANILLA-24) shows 1 unit remaining to be packed, while the Geek Vape: P Series Coils (SKU: GEEKVAPE-PSERIESCOIL-0.15) shows 2 units remaining. Clear, color-coded buttons (e.g., green for completed tasks) allow the packer to mark items as packed, ensuring clarity and reducing errors.

Gamified elements, such as progress bars and percentage indicators, visually motivate the packer to complete the task efficiently. The combination of real-time feedback and an organized, user-friendly layout fosters engagement and minimizes the risk of errors. These gamified features encourage adherence to guidelines while maintaining productivity.

In this specific example, the interface 304 shows that 0 out of 40 items have been scanned and accounted for. Highlighted items include Custard Monster: Vanilla, with 1 unit remaining, and Focus V: Intelli-Core Atomizers, with 1 unit remaining. These details ensure the packer maintains clear visibility into the progress of the task and any outstanding items.

### Controller/Processor Components

A processor or controller as described herein may include any suitable type of computing device, such as a central processing unit (CPU), microcontroller, graphics processing unit (GPU), system on a chip (SoC), or digital signal processor (DSP). It may operate with one or more cores and may be configured to execute the functions described in this disclosure.

The processor may be operably connected to one or more memory devices, such as random access memory (RAM), read-only memory (ROM), flash storage, or solid-state drives (SSD). These memory devices store computer-readable instructions that, when executed by the processor, perform the methods described. The processor and memory communicate via data buses or other suitable communication pathways.

The computing device may also include input/output (I/O) devices, such as a touchscreen, mouse, keyboard, display, or speaker, to facilitate interaction with users or other systems. Additionally, it may include a network interface, such as a wired or wireless communication module, for connecting to networks.

Control logic or software instructions may be stored in memory and executed by the processor to implement specific functionalities. This logic may be modular, consisting of software components, processes, or functions that work together to perform the operations described herein.

The described computing operations involve the manipulation of data represented as electrical, optical, or magnetic signals stored or transferred within the system. These operations are machine-executed and do not require manual intervention, though they may interface with human operators through appropriate user interfaces.

The systems and methods described are not limited to any particular hardware configuration or programming language and may be implemented on general-purpose or specialized computing devices.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for optimizing packing and shipping configurations, comprising
a plurality of processing agents configured to execute in parallel, each processing agent comprising:
a) a solution generator configured to generate a plurality of candidate packing configurations based on input data, the input data including item dimensions, item weights, allowable box dimensions, and shipping method parameters;
b) an optimization module configured to evaluate the candidate packing configurations based on a cost function and one or more constraints, the constraints including volume utilization and weight limits for the allowable box dimensions;
a solution exchange module configured to periodically transmit candidate packing configurations between the processing agents during execution to promote diversity in candidate solutions;
an iterative refinement module configured to adjust a packing configuration parameter, the packing configuration parameter including a fill rate for allowable box dimensions, when one or more candidate packing configurations fail to satisfy the constraints;
a validation module configured to verify the feasibility of the candidate packing configurations using a three-dimensional packing algorithm;
a control module configured to select an optimized packing configuration from the validated candidate packing configurations;
and a communication interface configured to output the optimized packing configuration to a downstream system.

2. The system of claim 1, wherein the solution generator of each processing agent is configured to generate candidate packing configurations using a biased random-key genetic algorithm.

3. The system of claim 2, wherein the biased random-key genetic algorithm assigns priorities to items based on random values and generates item-to-box assignments based on the assigned priorities.

4. The system of claim 1, wherein the optimization module of each processing agent is further configured to refine candidate packing configurations using mixed integer linear programming to satisfy the constraints.

5. The system of claim 1, wherein the solution exchange module is configured to transmit elite candidate packing configurations between the processing agents at predefined intervals during execution.

6. The system of claim 1, wherein the iterative refinement module is configured to reduce the fill rate for the allowable box dimensions by a predefined step size in response to candidate packing configurations failing the constraints.

7. The system of claim 1, wherein the validation module applies a three-dimensional bin-packing algorithm to verify the spatial feasibility of the candidate packing configurations.

8. The system of claim 7, wherein the three-dimensional bin-packing algorithm incorporates constraints based on item fragility, orientation, and compatibility.

9. The system of claim 1, wherein the cost function used by the optimization module incorporates shipping costs, box costs, and penalties for violating packing constraints.

10. The system of claim 1, wherein the processing agents are configured to operate in parallel on a distributed computing network.

11. The system of claim 1, wherein the communication interface is further configured to transmit the optimized packing configuration to a user interface for real-time display.

12. The system of claim 11, wherein the user interface comprises a gamified interface that displays packing progress metrics, including weight utilization and volume utilization for each box.

13. The system of claim 1, wherein the input data further includes item attributes selected from the group consisting of fragility, orientation constraints, and compatibility indices.

14. The system of claim 1, wherein the processing agents include a mutation module configured to introduce random variations into candidate packing configurations to prevent convergence on local optima.

15. The system of claim 1, wherein the solution exchange module implements migration rules to limit the number of candidate packing configurations transmitted between the processing agents.

16. The system of claim 1, wherein the control module selects the optimized packing configuration based on a predefined termination condition, the termination condition including a maximum number of iterations or a threshold improvement in the cost function.

17. The system of claim 1, wherein the optimization module evaluates the candidate packing configurations using real-time shipping rate data retrieved from external carrier systems.

18. The system of claim 1, wherein the iterative refinement module adjusts additional packing configuration parameters selected from the group consisting of box types, shipment counts, and shipping methods.

19. The system of claim 1, wherein the validation module outputs a list of infeasible items and corresponding constraint violations for failed candidate packing configurations.

20. The system of claim 1, wherein the communication interface is configured to generate a machine-readable output of the optimized packing configuration for integration with a warehouse management system.
